(19) United States
(12) Patent Application Publication
(10) Pub. No.: US 2009/0100954 A1
(43) Pub. Date: Apr. 23, 2009

(54) Control unit for automatic transmission

(75) Inventors: Yoshinobu Ito, Anjo (JP); Michimasa Tanaka, Anjo (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-Shi (JP)

(21) Appl. No.: 12/285,070

(22) Filed: Sep. 29, 2008

(30) Foreign Application Priority Data
Sep. 28, 2007 (JP) 2007-253344

(51) Int. Cl. F16H 61/32

(52) U.S. Cl. 74/473.12

(57) ABSTRACT

An automatic transmission control unit includes an actuator that changes a travel range of an automatic transmission; a shift-by-wire control circuit that controls the actuator in order to change the travel range of the automatic transmission to a selected range selected by a driver; an automatic transmission control circuit that controls a shift speed of the automatic transmission by at least a travel range position signal; and a control unit case that encloses the actuator, the shift-by-wire control circuit, and the automatic transmission control circuit, and is fixed by a fixing member to an automatic transmission case, wherein: the actuator is disposed within the control unit case on an automatic transmission case side, and the shift-by-wire control circuit and the automatic transmission control circuit are disposed within the control unit case on a side opposite the automatic transmission case side.

The disclosure of Japanese Patent Application No. 2007-253344 filed on Sep. 28, 2007 including the specification, drawings and abstract is incorporated herein by reference in its entirety.

### BACKGROUND

The present invention relates to an automatic transmission control unit.

There exists a vehicle mounted with a shift-by-wire system equipped with an actuator 130 that changes a travel range of a vehicle automatic transmission 140, and a shift-by-wire control circuit (referred to as an SBW-ECU below) 110 that controls the actuator 130 based on a required range selected by a driver, as shown in FIG. 10. An automatic transmission control circuit (referred to as an AT-ECU below) 120 is mounted in the vehicle that controls various valves of a hydraulic control device of the automatic transmission 140. The actuator 130, the SBW-ECU 110, and the AT-ECU 120 are separately accommodated, with the SBW-ECU 110 and the AT-ECU 120 connected via connectors 111, 121 by harnesses 102, 103 to an engine ECU 100 that controls an engine. The SBW-ECU 110 and the actuator 130 are connected via connectors 112, 132 by a harness 113. The engine ECU 100, the SBW-ECU 110, and the AT-ECU 120 are connected to an onboard communication system CAN (Controller Area Network) 101, and are capable of communicating with one another according to CAN protocol. The SBW-ECU 110 includes a power source, a motor CPU, a power source CPU, a CAN interface, a motor drive circuit, a shift interface, and an SBW-specific vehicle interface, and is also connected with a shift lever 115 via the connector 111. The AT-ECU 120 includes a power source, an AT CPU, a CAN interface, and an AT interface, and is connected with the automatic transmission 140.

However, in the conventional shift-by-wire system above, the actuator 130, the SBW-ECU 110, and the AT-ECU 120 being separately accommodated, and the SBW-ECU 110 and the AT-ECU 120 respectively having similar circuit functions including power sources and CAN interfaces, also results in an increased number of parts and manufacturing costs. Furthermore, since the actuator 130, the SBW-ECU 110, and the AT-ECU 120 are connected via the plurality of connectors 111, 112, 121, 132 by the harnesses 102, 103, 113, it is necessary to avoid contact failures and the like to secure high reliability. Noise countermeasures using shielding wire must also be enacted for the harness 113 through which a drive current of a motor 131 flows.

A shift-by-wire system that integrates the actuator and the SBW-ECU has been proposed in Japanese Patent Application Publication No. JP-A-2007-10042 as a countermeasure. According to this shift-by-wire system, the actuator and the SBW-ECU are stored in one case, which enables downsizing.

### SUMMARY

According to the shift-by-wire system described in Japanese Patent Application Publication No. JP-A-2007-10042, however, the AT-ECU is stored in a separate case, which leaves room for further downsizing, and furthermore, the SBW-ECU and the AT-ECU have similar circuit functions as well as a wire harness electrically connecting the SBW-ECU and the AT-ECU. This results in an increased number of parts and manufacturing costs.

Vehicles are constantly subjected to vibrations. In a control unit integrating the actuator, the SBW-ECU, and the like, the operation of the actuator, which is a heavy body, may generate vibrations with respect to an ECU. Sufficient vibration resistance must therefore be secured. However, the shift-by-wire system described in Japanese Patent Application Publication No. JP-A-2007-10042 does not take into consideration such problems.

The present invention was devised in light of the foregoing problems, and it is an object of the present invention to provide an automatic transmission control unit that enables downsizing and a reduction in manufacturing costs, and also has good vibration resistance. The present invention can also achieve various other advantages.

According to an exemplary aspect of the invention, an automatic transmission control unit includes an actuator that changes a travel range of an automatic transmission; a shift-by-wire control circuit that controls the actuator in order to change the travel range of the automatic transmission to a selected range selected by a driver; an automatic transmission control circuit that controls a shift speed of the automatic transmission by at least a travel range position signal; and a control unit case that encloses the actuator, the shift-by-wire control circuit, and the automatic transmission control circuit, and is fixed by a fixing member to an automatic transmission case, wherein: the actuator is disposed within the control unit case on an automatic transmission case side, and the shift-by-wire control circuit and the automatic transmission control circuit are disposed within the control unit case on a side opposite the automatic transmission case side.

According to an exemplary aspect of the invention, an automatic transmission control unit includes an actuator that changes a travel range of an automatic transmission; a shift-by-wire control circuit that controls the actuator in order to change the travel range of the automatic transmission to a selected range selected by a driver; an automatic transmission control circuit that controls a shift speed of the automatic transmission by at least a travel range position signal; and a control unit case that encloses the actuator, the shift-by-wire control circuit, and the automatic transmission control circuit, and is fixed by a fixing member to an automatic transmission case, wherein: the actuator is disposed within the control unit case on a side where the control unit case is fixed to the automatic transmission case, and the shift-by-wire control circuit and the automatic transmission control circuit are disposed on a side surface of the control unit case opposite to the side where the control unit case is fixed to the automatic transmission case.

According to an exemplary aspect of the invention, an automatic transmission control unit includes an actuator that changes a travel range of an automatic transmission; a shift-by-wire control circuit that controls the actuator in order to change the travel range of the automatic transmission to a selected range selected by a driver; an automatic transmission control circuit that controls a shift speed of the automatic transmission by at least a travel range position signal; and a control unit case that encloses the actuator, the shift-by-wire control circuit, and the automatic transmission control circuit, and is fixed by a fixing member to an automatic transmission case, wherein: the control unit case is divided into a first storage portion that accommodates the actuator and a second storage portion that accommodates the shift-by-wire control circuit and the automatic transmission control circuit, and the first storage portion is adjacent to the automatic transmission case.

### BRIEF DESCRIPTION OF THE DRAWINGS

Various exemplary aspects of the invention will be described with reference to the drawings, wherein:

FIG. 1 is an electrical connection diagram of an automatic transmission control unit according to first and second embodiments;

FIG. 2 is a perspective view of the automatic transmission control unit according to the first embodiment;

FIG. 3 is a cross-sectional view of the automatic transmission control unit according to the first embodiment;

FIG. 4 is a frontal view of a control circuit mechanism and an inner lid for the automatic transmission control unit according to the first embodiment;

FIG. 5 is a block diagram of an automatic transmission for the automatic transmission control unit according to the first and second embodiments;

FIG. 6 is a frontal view of an actuator for the automatic transmission control unit according to the first embodiment;

FIG. 7 is a perspective view of a range changeover mechanism for the automatic transmission control unit according to the first and second embodiments;

FIG. 8 is a perspective view of the automatic transmission control unit according to the second embodiment;

FIG. 9 is a cross-sectional view of the automatic transmission control unit according to the second embodiment; and

FIG. 10 is an electrical connection diagram of a conventional automatic transmission control unit.

### DETAILED DESCRIPTION OF EMBODIMENTS

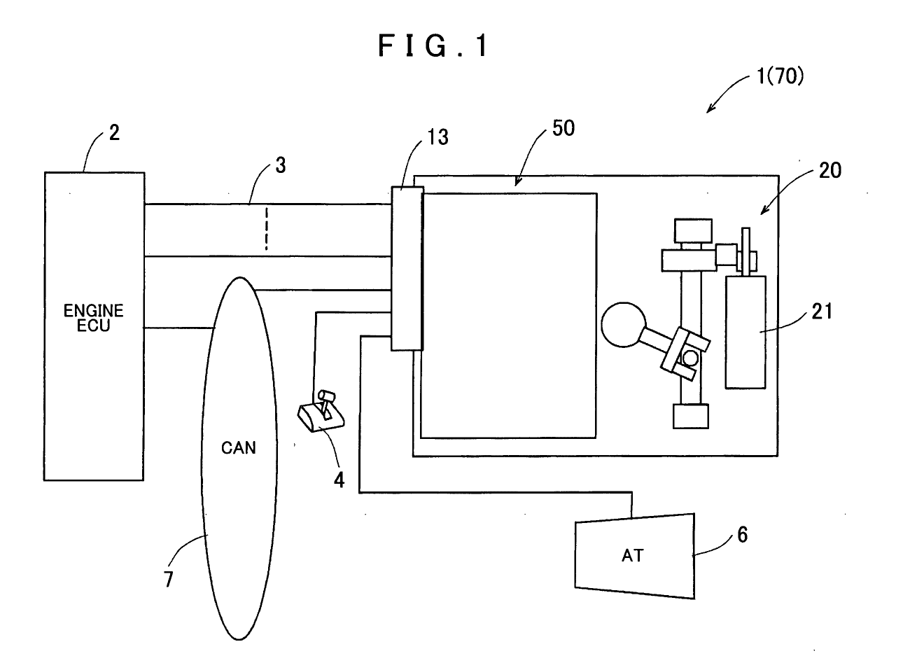

First and second embodiments that realize an automatic transmission control unit according to the present invention will be described below with reference to the accompanying drawings. As FIG. 1 shows, an automatic transmission control unit 1 (referred to as a control unit 1 below) of the first embodiment is connected to an engine ECU 2 by a harness 3 via a connector 13, and also connected to a shift lever 4 and an automatic transmission 6. Here, the engine ECU 2 controls an engine, and the shift lever 4 is operated by a driver in order to set a travel range of the automatic transmission 6 to a desired range. The automatic transmission 6 automatically changes a transmission gear ratio in accordance with a vehicle speed, an accelerator angle, a travel range, and the like. The control unit 1 and the engine ECU 2 are connected by an onboard communication system CAN (Controller Area Network) 7 for example, and are capable of communicating with one another.

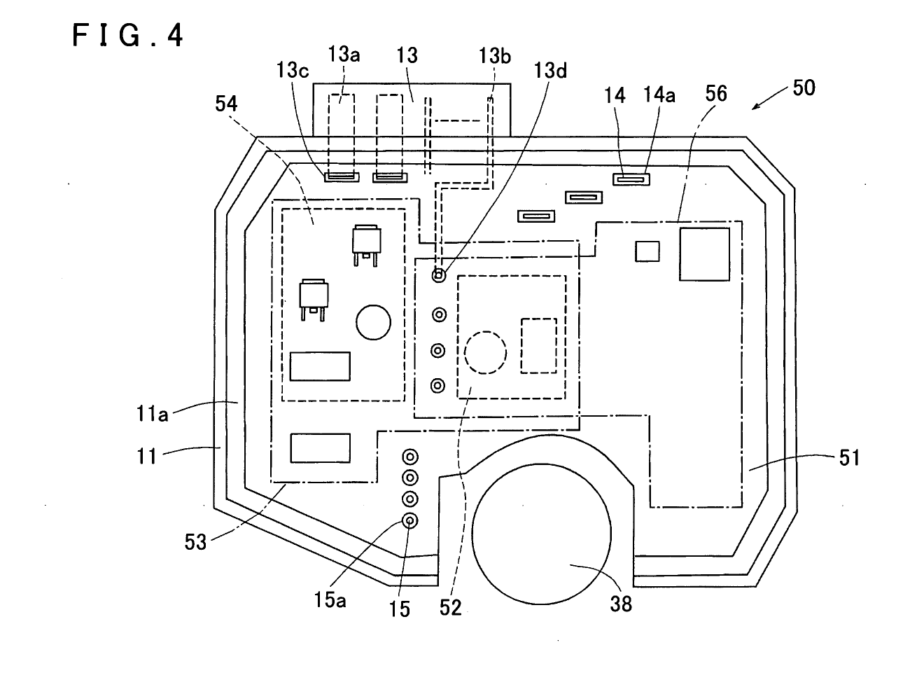

The control unit 1 is provided with an actuator 20 and a control circuit mechanism 50. The actuator 20 is provided with a motor 21 that changes a travel range (such as P, R, N, D, D1, and D2) of the automatic transmission 6, while the control circuit mechanism 50 includes one printed circuit board 51 mounted with a shift-by-wire control circuit (referred to as an SBW-ECU below) 53, an automatic transmission control circuit (referred to as an AT-ECU below) 56, and the like as will be explained later (see FIG. 4).

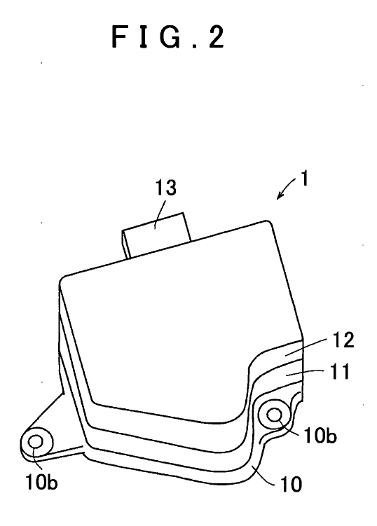

FIG. 2 is a view showing an outer appearance of the control unit 1. A control unit case 1A of the control unit 1 is structured from a case body 10 made of metal, an inner lid 11 made of resin, and a top lid 12 made of metal. The inner lid 11 is formed integrated with the connector 13. The control unit 1 is fixed by a bolt to a case 6A of the automatic transmission 6 using an attachment hole 10b provided in the case body 10, and thereby fixed to the automatic transmission case 6A. Note that the case body 10 may instead be made of resin.

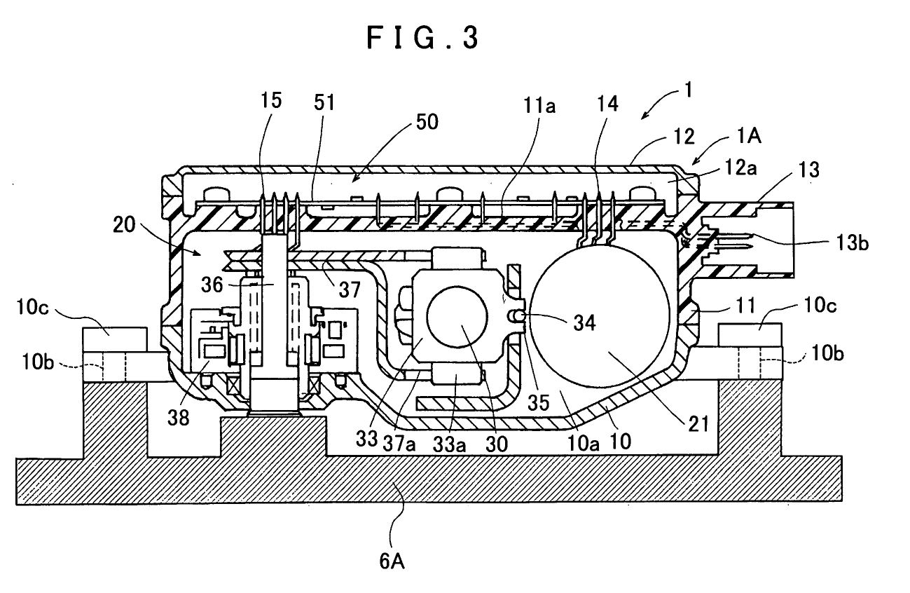

FIG. 3 is a cross-sectional view of the control unit 1. The control unit 1 is provided with one control unit case 1A structured from the case body 10, the inner lid 11, and the top lid 12 disposed in that order starting from the automatic transmission case 6A side, and also provided with the actuator 20 disposed and accommodated on the automatic transmission case 1A side, as well as the control circuit mechanism 50 disposed on a far side from the automatic transmission case 6A within the case 1A. Provided on the inner lid 11 is a separation wall 11a with a plate shape that forms a lower storage portion 10a (first storage portion) with the case body 10. The actuator 20 and a position sensor 38 are accommodated within the lower storage portion 10a by fixing the actuator 20 and the position sensor 38 to the case body 10 and the inner lid 11 through adhesion with an adhesive or using a fixing member such as a screw. By covering the inner lid 11 with the top lid 12, an upper storage portion 12a (second storage portion) is formed between the inner lid 11 and the top lid 12, and the control circuit mechanism 50 is accommodated within the upper storage portion 12a. Note that the top lid 12 may instead be made of resin, and the inner lid 11 and the top lid 12 are fixed by screws, adhesion, vibration welding, or the like.

FIG. 4 is a frontal view of the control circuit mechanism 50 and the inner lid 11 with the top lid 12 removed. The control circuit mechanism 50 is formed from the printed circuit board 51 mounted with electronic components structuring the SBW-ECU 53 serving as the shift-by-wire control circuit and the AT-ECU 56 serving as the automatic transmission control circuit. The printed circuit board 51 is threadedly fixed on the separation wall 11a of the inner lid 11. The SBW-ECU 53 and the AT-ECU 56 share a power circuit 52, and the SBW-ECU 53 includes a motor drive circuit 54. Here, the SBW-ECU 53 drives the actuator 20 based on a selected range selected by the driver. By controlling various valves of a hydraulic control device of the automatic transmission 6 based on information such as an operating state of the engine as input from the engine ECU 2, a travel range position signal from the SBW-ECU 53, and a vehicle traveling speed, the AT-ECU 56 performs a control to change an engagement state of clutches and brakes in order to change a shift state. Furthermore, the power circuit 52 stabilizes a power voltage at a predetermined voltage, which is then supplied to other circuits of the SBW-ECU 53 and the AT-ECU 56. The motor drive circuit 54 supplies a motor drive current to the motor 21.

As FIGS. 3 and 4 show, an end of the inner lid 11 is formed integrated with the connector 13, and the connector 13 is provided with a power terminal 13a and a signal terminal 13b. The connector 13 is internally divided among each of the engine ECU 2, the shift lever 4, the automatic transmission 6, and the CAN 7, and electrically connectable with these. The power terminal 13a supplies power to the power circuit 52. An end of the power terminal 13a projects into the connector 13 and passes through the inside of the inner lid 11 (the separation wall 11a), while another end bent into an L shape projects upward from the separation wall 11a and is soldered to a land 13c of the printed circuit board 51. The power terminal 13a is connected with an IC of the power circuit 52 via a pattern connected with the land 13c. The signal terminal 13b transfers signals from sensors and commands or the like from the AT-ECU 56. An end of the signal terminal 13b projects into the connector 13 and passes through the inside of the inner lid 11 (the separation wall 11a), while another end bent into an L shape projects upward from the separation wall 11a and is soldered to a land 13d of the printed circuit board 51. The signal terminal 13b is connected with the SBW-ECU 53 and the AT-ECU 56 via a pattern connected with the land 13d. In this manner, an electrical insulation property is secured by passing the power terminal 13a and the signal terminal 13b through the inside of the inner lid 11 (the separation wall 11a).

A bus bar 14, which serves as a conductor, conducts the motor drive current, and an end of the bus bar 14 is soldered to a land 14a of the printed circuit board 51 that is connected with an IC of the motor drive circuit 54. In addition, the bus bar 14 passes through the inside of the separation wall 11a, and another end of the bus bar 14 projects downward from the separation wall 11a and is connected with the motor 21 of the actuator 20. A signal conducting wire 15 transfers a signal detected by the position sensor 38 to the SBW-ECU 53, and an end of the signal conducting wire 15 is soldered to a land 15a of the printed circuit board 51 that is connected with an IC of the SBW-ECU 53. In addition, the signal conducting wire 15 passes through the inside of the separation wall 11a, and another end of the signal conducting wire 15 projects downward from the separation wall 11a and is connected with the position sensor 38.

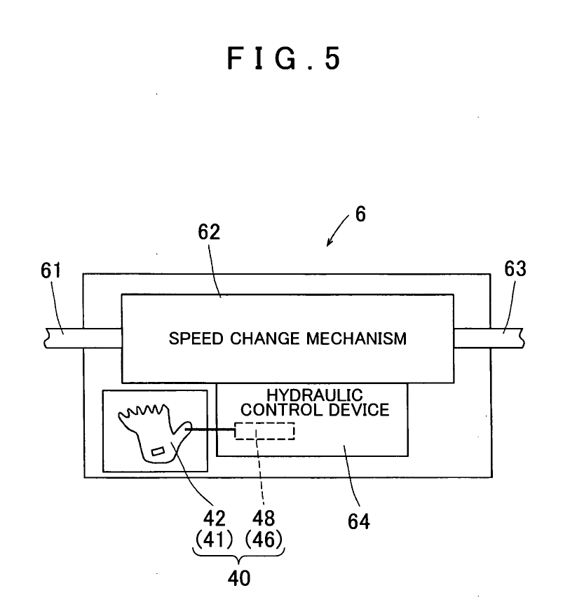

FIG. 5. is a block diagram of the automatic transmission 6 subject to the control of the AT-ECU 56. The automatic transmission 6 automatically changes the transmission gear ratio to change the speed of the driving force of the engine in accordance with the vehicle speed, the accelerator angle, the travel range, and the like, which is then transferred to a driving wheel after passing through a propeller shaft, a differential, and right and left drive shafts. The automatic transmission 6 includes an input shaft 61, a speed change mechanism 62, an output shaft 63, the hydraulic control device 64, and the range changeover mechanism 40. The input shaft 61 inputs a driving force from the engine. The speed change mechanism 62 is formed from a torque converter, a planetary gear train, and the like, and switches (changes or reverses) a gear speed after receiving an instruction from the hydraulic control device 64, whereby the speed of the driving force input from the input shaft 61 is changed and output. The output shaft 63 outputs a speed-changed power from the speed change mechanism 62 to the driving wheel via the propeller shaft. The hydraulic control device 64 automatically changes the oil passages of the clutches and brakes of gears in the planetary gear train to control the planetary gear train. The range changeover mechanism 40 will be described later.

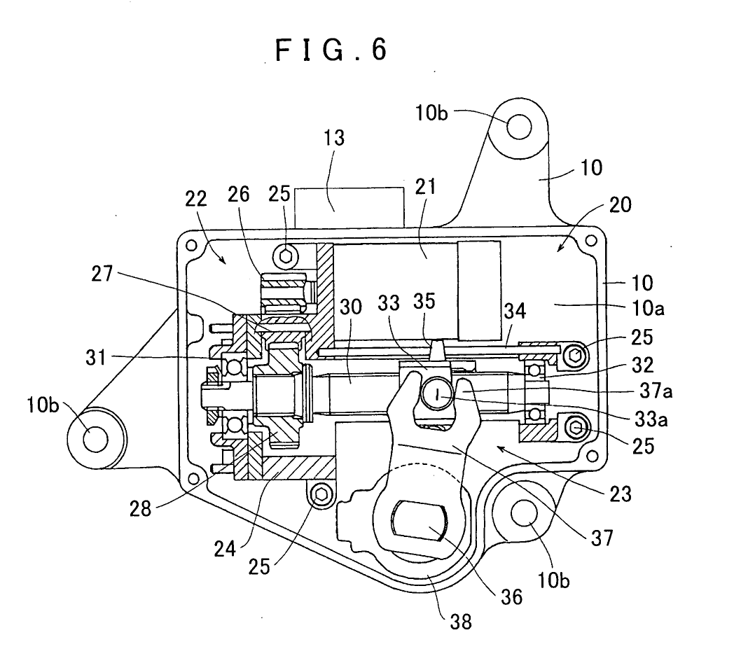

FIG. 6 is a frontal view of the actuator 20 and the position sensor 38 with the top lid 12 and the inner lid 11 removed. As also shown in FIG. 3, the actuator 20 and the position sensor 38 are accommodated within the lower storage portion 10a formed by the case body 10 and the inner lid 11 having the separation wall 11a. The actuator 20 is structured from the motor 21, a reduction mechanism 22, a motion conversion mechanism 23, and the like. Reference numeral 24 denotes a main bracket made of metal separate from the case body 10 which, after attachment to the motor 21, the reduction mechanism 22, the motion conversion mechanism 23, and the like, is fixed to the case body 10 by four bolts 25. The motor 21 is fixed to the main bracket 24, and an output shaft of the motor 21 passes through the main bracket 24 to project forward with a small gear 26 fitted to a distal end portion thereof. The motor 21 is a three-phase brushless motor, and is attached with a sensor that sends a pulse signal each time the output shaft rotates a unit angle. The motor 21 used is compact so as to enable storage within the case body 10.

Inside the case body 10, a ball screw shaft 30 is arranged parallel to the motor 21 and both ends of the ball screw shaft 30 are rotatably and axially supported on the main bracket 24 via bearings 31, 32. A front end side of the ball screw shaft 30 is fixed with a large gear 28 that meshes via the small gear 26 and an intermediate gear 27. The small gear 26, the intermediate gear 27, and the large gear 28 structure the reduction mechanism 22. Note that in the present embodiment, the rotation of the motor 21 decelerated by the small gear 26, the intermediate gear 27, and the large gear 28 is transferred to the ball screw shaft 30. However, the rotation of the motor 21 may be decelerated by a planetary gear, a worm gear, or the like, and then transferred to the ball screw shaft 30.

The ball screw shaft 30 is threadedly engaged with a ball nut 33. Both ends of an engagement rod 34 that extends parallel to the ball screw shaft 30 are fitted to the main bracket 24. A C-shaped engagement portion 35 that protrudes toward an outer periphery of the ball nut 33 is engaged with the engagement rod 34, and the ball nut 33 is held movable in an axial direction with respect to the main bracket 24. Thus, rotation of the motor 21 is decelerated by the reduction mechanism 22 and transferred to the ball screw shaft 30 and rotation of the ball screw shaft 30 is converted into axial motion of the ball nut 33 by the ball screw shaft 30, the ball nut 33, and the like.

An end of a manual shaft 36 projects inside the lower storage portion 10a and is rotatably supported on the case body 10. A base end portion of an arm 37 is fitted to the manual shaft 36 with a relative rotation of the arm 37 thus regulated and the arm 37 supported capable of oscillation. A distal end of the arm 37 branches into two and extends toward both sides of the ball nut 33, where respective concave portions 37a are formed on the distal ends. Through engagement of the concave portions 37a with an engagement shaft 33a provided extending toward both sides of the ball nut 33, the arm 37 is engaged with relative movement thereof in the axial direction of the ball screw shaft 30 regulated. The ball screw shaft 30, the ball nut 33, the arm 37, the engagement shaft 33a, the concave portion 37a, and the like structure the motion conversion mechanism 23. In addition, an end of the manual shaft 36 is attached with the position sensor 38.

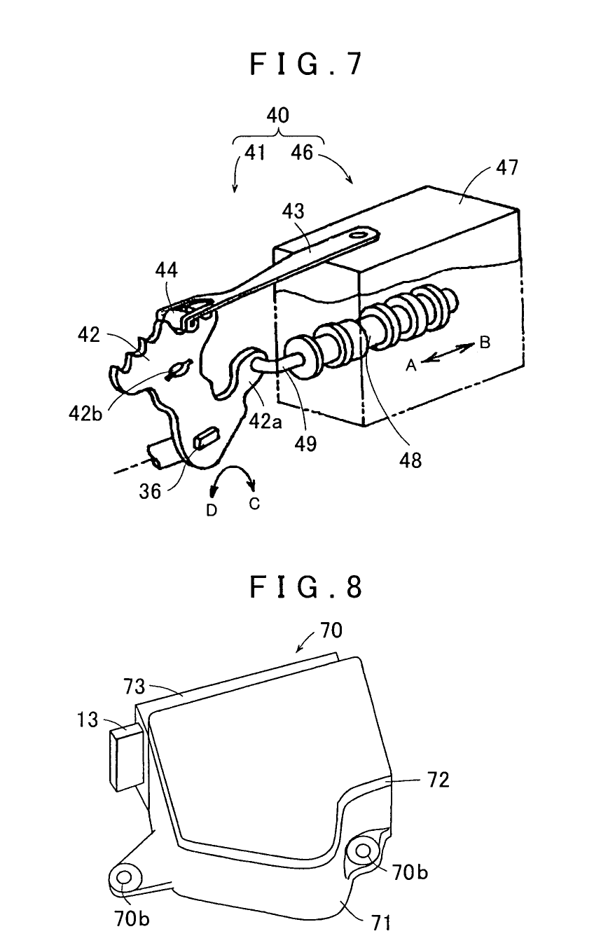

Another end of the manual shaft 36 is connected with the range changeover mechanism 40 subject to driving by the actuator 20, as shown in FIG. 7. The range changeover mechanism 40 is provided in the automatic transmission 6 (see FIG. 5). The range changeover mechanism 40 is formed from a detent mechanism 41 and a manual valve 46. The manual valve 46 is structured such that a spool 48 is fitted movable in an axial direction (the directions of arrows A and B) within a valve body 47. The spool 48 changes an oil passage of line pressure in accordance with a range selected by the shift lever 4, and changes a drive state of the automatic transmission 6 to a travel range such as a P-range (parking range), an R-range (reverse range), an N-range (neutral range), and a D-range (driving range). The shift lever 4 is set such that ranges corresponding to the travel ranges of the automatic transmission 6 can be selected. Namely, the spool 48 disposed within a hydraulic control device 64 of the automatic transmission 6 is capable of moving to a P-position corresponding to the P-range, an R-position corresponding to the R-range, an N-position corresponding to the N-range, a D-position corresponding to the D-range, and the like. Moving the spool 48 in the axial direction (the directions of the arrows A and B) changes the oil passage within the hydraulic control device 64, whereby the travel range of the automatic transmission 6 is set so as to be a range selected by the shift lever 4, i.e., a required range. A portion projecting from the valve body 47 of the spool 48 is formed with a hook portion 49 bent into an L shape. The hook portion 49 is connected to a shift portion 42a that is formed on a detent lever 42 (to be described later) of the detent mechanism 41. Rotation of the detent lever 42 moves the spool 48 in the axial direction.

The detent mechanism 41 is structured from the detent lever 42, a detent spring 43, and an engagement roller 44. The detent lever 42 integrally rotates with the manual shaft 36 and the arm 37. Accordingly, the detent lever 42 rotates in the directions of arrows C and D with the manual shaft 36 serving as the center of rotation. The detent lever 42 is also provided with a through hole 42b that is engaged with a portion of a parking mechanism (not shown). The position sensor 38, which is attached to an end of the manual shaft 36, detects a rotational position of the detent lever 42 so as to detect a current position of the spool 48. A potentiometer, for example, may be used as the position sensor 38, with the potentiometer outputting a voltage in accordance with a rotational angle of the manual shaft 36. The range position (P-position, R-position, N-position, and D-position) can thus be detected as a zone of a predetermined width depending on the voltage level output from the potentiometer.

A description follows below regarding an operation of the SBW-ECU 53 and the actuator 20 in the control unit 1 with the above structure. When the driver operates the shift lever 4, a shift signal based on the selected range selected is input to the SBW-ECU 53 via the signal terminal 13b of the connector 13. A motor drive current based on the shift signal is then supplied from the SBW-ECU 53 to the motor 21 via the bus bar 14.

Accordingly, the motor 21 is driven in a predetermined driving direction, and rotational motion of the output shaft of the motor 21 is decelerated by the reduction mechanism 22 and transferred to the ball screw shaft 30 supported on the main bracket 24. Rotation of the ball screw shaft 30 moves the ball nut 33, whose rotation is regulated by engagement of the engagement rod 39 and the engagement portion 35, in the axial direction to thus rotate the arm 37 around the manual shaft 36. Rotation of the manual shaft 36 rotates the detent lever 42, and the spool 48 is moved via the shift portion 42a.

The SBW-ECU 53 stops rotation of the motor 21 when an output voltage of the position sensor 38 reaches a predetermined value. Once rotation of the motor 21 is stopped, the detent lever is rotated due to the actions of the detent spring 43, the engagement roller 44, and the like, and then held at a predetermined position. In this manner, the spool 48 is changed, which changes the travel range of the automatic transmission 6.

Actions of the AT-ECU 56 will be outlined next. The AT-ECU 56 is input with information indicating an operation state such as the engine speed from the engine ECU 2 via the signal terminal 13b of the connector 13. Based on such information, the AT-ECU 56 outputs to the automatic transmission 6 a control signal that controls various valves of the hydraulic control device of the automatic transmission 6. The engagement states of the clutches and brakes are thus changed to change the shift state.

In the control unit 1 according to the first embodiment, regarding the arrangement of the actuator 20, the SBW-ECU 53, and the AT-ECU 56, the actuator 20 is disposed and fixed on an automatic transmission case side within the control unit case 1A, which is fixed by a fixing member 10c to the automatic transmission case 6A, whereas the SBW-ECU 53 and the AT-ECU 56 are disposed on a side far from the automatic transmission case 6A opposite the actuator 20. Therefore, in a vehicle subject to constant vibration, vibrations of the heavy actuator 20 can be suppressed and good stability achieved. In other words, the case body 10 of the control unit case 1A fixed with the actuator 20 is fixed to the automatic transmission case 6A by the fixing member 10c, which is a bolt or the like, that passes through the attachment hole 10b. Therefore, the heavy actuator 20 can be reliably fixed to the automatic transmission case 6A. Operation of the actuator may generate conductive foreign bodies and possibly cause a short circuit in an ECU electronic component; however, the risk of such occurrences can be reduced.

The actuator 20 and the control circuit mechanism 50, which includes the SBW-ECU 53 and the AT-ECU 56, are accommodated within one control unit case 1A that includes the upper storage portion 12a and the lower storage portion 10a, which are vertically divided by the separation wall 11a. There is thus no need to provide respective onboard spaces, and similar circuit functions can also be used in common. The lower storage portion 10a accommodates the heavy actuator 20, and the upper storage portion 12a accommodates the lightweight control circuit mechanism 50. Therefore, good stability can be achieved in a vehicle subject to constant vibration. In addition, the actuator 20 structured from the motor 21, the reduction mechanism 22, the motion conversion mechanism 23, and the like, is fixed by the main bracket 24 made of metal separate from the case body 10 to the case body 10 using four bolts 25. Accordingly, the control unit 1 of the first embodiment is capable of achieving downsizing and a reduction in manufacturing costs, and also has good vibration resistance. In particular, mounting the SBW-ECU 53 and the AT-ECU 56 on one printed circuit board 51 in the control unit 1 enables the easy realization of a compact space and the common use of similar circuit functions. Furthermore, since wiring for the actuator 20 and the SBW-ECU 53 is accommodated in one case, the actuator 20 cannot be forcibly driven from outside, which can help prevent theft of the vehicle. Also, in the control unit 1, the storage portions divided by the separation wall 11a respectively accommodate the actuator 20, and the SBW-ECU 53 and the AT-ECU 56. Therefore, lubricant present in the actuator 20, wear particles generated from the reduction mechanism 22 and so forth can be prevented from penetrating to the storage portion where the SBW-ECU 53 and the AT-ECU 56 are accommodated.

In the control unit 1, the separation wall 11a is embedded with the bus bar 14 that electrically connects the actuator 20 and the printed circuit board 51. Therefore, the actuator drive current can flow through the bus bar 14 instead of an inner layer pattern of the printed circuit board 51, thereby downsizing the printed circuit board 51 and also eliminating the need for shielding wire as a noise countermeasure.

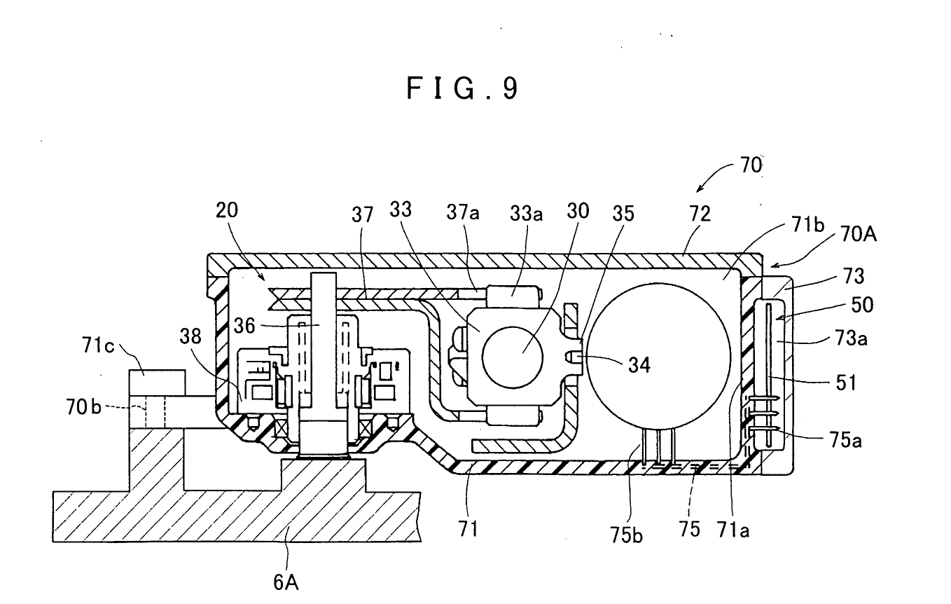

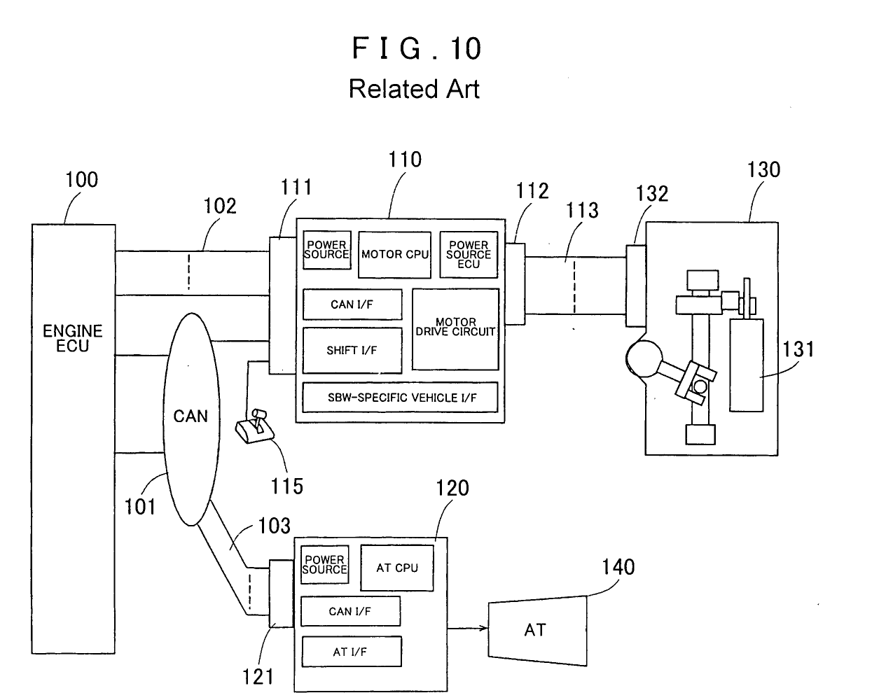

The automatic transmission control unit of the second embodiment has the structure shown in FIG. 1, similar to that of the first embodiment. FIG. 8 is a view showing an outer appearance of an automatic transmission control unit 70 (referred to as a control unit 70 below) according to the second embodiment. A control unit case 70A of the control unit 70 is structured by a case body 71 made of resin, and a top lid 72 and a side lid 73 made of metal. The control unit 70 is fixed to the automatic transmission case 6A using an attachment hole 70b provided in the case body 71, and thereby fixed to the case 6A of the automatic transmission 6 by a fixing member 71c such as a bolt as disclosed in FIG. 9.

FIG. 9 is a cross-sectional view of the control unit 70. The control unit 70 is provided with one case structured from the case body 71, the top lid 72, and the side lid 73, and also provided with the actuator 20 and the control circuit mechanism 50 accommodated within the case. A first storage portion 71b is formed as a lower storage portion between the case body 71 and the top lid 72, and the actuator 20 and the position sensor 38 are accommodated within the first storage portion 71b. The actuator 20 and the position sensor 38 are identical to that of the first embodiment but with a shorter manual shaft 36, and will not be explained here. A second storage portion 73a is formed as a side storage portion between the top lid 72 and the side lid 73, and the printed circuit board 51 structuring the control circuit mechanism 50 is accommodated within the second storage portion 73a.

The side lid 73 side of the case body 71 serves as a separation wall 71a. An end of the separation wall 71a is formed integrated with the connector 13 identical to that of the first embodiment, and projects toward a rear surface direction in FIG. 9. The printed circuit board 51 is threadedly fixed to the separation wall 71a, and the printed circuit board 51 is accommodated within the second storage portion 73a. The printed circuit board 51 is also mounted with electronic components that are identical to that of the first embodiment but in a different layout. However, a bus bar 75 serving as a conductor that conducts the motor drive current has an end 75a that is soldered to the printed circuit board 51 and passes through the inside of the case body 71 (the separation wall 71a), and another end 75b that projects upward from the case body 71 and connects with the motor 21 of the actuator 20. A signal conducting wire that transmits a signal detected by the position sensor 38 to the SBW-ECU 53 is not shown. However, similar to the bus bar 75, the signal conducting wire has an end that is soldered to the printed circuit board 51 and passes through the inside of the case body 71 (the separation wall 71a), and another end that projects upward from the case body 71 and connects with the position sensor 38.

In the control unit 70 according to the second embodiment, the actuator 20 and the control circuit mechanism 50, which includes the SBW-ECU 53 and the AT-ECU 56, are accommodated within one control unit case 70A that includes the first storage portion 71b and the second storage portion 73a, which are laterally divided by the separation wall 71a. There is thus no need to provide respective onboard spaces, and similar circuit functions can also be used in common. The heavy actuator 20, which is controlled by the SBW-ECU 53 and changes the travel range of the automatic transmission 6, is disposed and fixed on the automatic transmission case 6A side within the control unit case 1A, which is fixed by the fixing member 71c to the automatic transmission case 6A. Meanwhile, the control circuit mechanism 50 that is more lightweight than the actuator 20 is disposed on a side surface of the control unit case 70A. Therefore, in a vehicle subject to constant vibration, vibrations of the heavy actuator can be suppressed and good stability achieved. Accordingly, the control unit 70 of the second embodiment is capable of achieving downsizing and a reduction in manufacturing costs, and also has good vibration resistance. Other structures, operations, and effects are identical to the first embodiment.

The control units 1, 70 in the present invention were described in the context of the first and second embodiments; however, the present invention is not limited to such, and may be applied with modification as appropriate provided that such modifications do not contradict the technical concept of the present invention.

The automatic transmission control unit according to the present invention is suitable for use as an automatic transmission control unit, which includes an actuator that changes a travel range of an automatic transmission for a vehicle; a shift-by-wire control circuit that controls the actuator based on a selected range selected by a driver; and an automatic transmission control circuit that controls various valves of a hydraulic control device of the automatic transmission.

According to an exemplary aspect of the invention, a heavy actuator, which is controlled by a shift-by-wire control circuit and changes a travel range of an automatic transmission, is disposed and fixed on an automatic transmission case side within a control unit case, which is fixed by a fixing member to an automatic transmission case. Meanwhile, the shift-by-wire control circuit and an automatic transmission control circuit, which are more lightweight than the actuator, are disposed on a side opposite the actuator far from the automatic transmission case. Therefore, in a vehicle subject to constant vibration, vibrations of the heavy actuator can be suppressed and good stability can be achieved. In addition, the actuator, the shift-by-wire control circuit, and the automatic transmission control circuit are accommodated within one case. There is thus no need to provide respective onboard spaces, and similar circuit functions can also be used in common. Accordingly, the automatic transmission control unit is capable of achieving downsizing and a reduction in manufacturing costs, and also has good vibration resistance. Furthermore, since wiring for the actuator, the shift-by-wire control circuit, and the automatic transmission control circuit is accommodated in one case, the actuator cannot be forcibly driven from outside, which can help prevent theft of the vehicle.

According to an exemplary aspect of the invention, a heavy actuator, which is controlled by a shift-by-wire control circuit and changes a travel range of an automatic transmission, is disposed and fixed on an automatic transmission case side within a control unit case, which is fixed by a fixing member to the automatic transmission case. Meanwhile, the shift-by-wire control circuit and an automatic transmission control circuit, which are more lightweight than the actuator, are disposed on a side surface of the control unit case. Therefore, in a vehicle subject to constant vibration, vibrations of the heavy actuator can be suppressed and good stability can be achieved. In addition, the actuator and a control unit including the shift-by-wire control circuit and the automatic transmission control circuit are accommodated within one case. There is thus no need to provide respective onboard spaces, and similar circuit functions can also be used in common. Accordingly, the automatic transmission control unit is capable of achieving downsizing and a reduction in manufacturing costs, and also has good vibration resistance. Furthermore, since wiring for the actuator, the shift-by-wire control circuit, and the automatic transmission control circuit is accommodated in one case, the actuator cannot be forcibly driven from outside, which can help prevent theft of the vehicle.

According to an exemplary aspect of the invention, the control unit case has an attachment hole, and is fixed to the automatic transmission case. Therefore, the heavy actuator can be reliably fixed to the automatic transmission case and vibration resistance improved.

According to an exemplary aspect of the invention, a control circuit mechanism including the shift-by-wire control circuit and the automatic transmission control circuit is fixed to a surface opposite a surface on an actuator side of a separation wall that divides an interior of the control unit case into two storage portions. Therefore, in an automatic transmission control unit where the actuator, the shift-by-wire control circuit, and the automatic transmission control circuit are integrated, operation of the actuator may generate conductive foreign bodies and possibly cause a short circuit in an ECU electronic component; however, the risk of such occurrences can be reduced.

According to an exemplary aspect of the invention, the heavy actuator is disposed in a lower storage portion on an automatic transmission case side within the control unit case, which is fixed by the fixing member to the automatic transmission case. Meanwhile, the shift-by-wire control circuit and the automatic transmission control circuit, which are more lightweight than the actuator, are disposed in an upper storage portion or a side storage portion. Therefore, in a vehicle subject to constant vibration, good stability can be achieved. Since the actuator and both control circuits are disposed in separate storage portions, even if operation of the actuator generates conductive foreign bodies, it is possible to prevent short-circuiting of electronic components of both control circuits.

According to an exemplary aspect of the invention, the shift-by-wire control circuit and the automatic transmission control circuit structure a control circuit mechanism mounted on one printed circuit board. Therefore, a compact space and the common use of similar circuit functions can be easily realized.

According to an exemplary aspect of the invention, the upper storage portion and the lower storage portion or the side storage portion are divided by a separation wall, and a conductor that electrically connects the actuator and the printed circuit board is embedded in the separation wall. Therefore, an actuator drive current can flow through the conductor instead of an inner layer pattern of the printed circuit board, thereby downsizing the printed circuit board and also eliminating the need for shielding wire as a noise countermeasure.

1. An automatic transmission control unit comprising:
an actuator that changes a travel range of an automatic transmission;
a shift-by-wire control circuit that controls the actuator in order to change the travel range of the automatic transmission to a selected range selected by a driver;
an automatic transmission control circuit that controls a shift speed of the automatic transmission by at least a travel range position signal; and
a control unit case that encloses the actuator, the shift-by-wire control circuit, and the automatic transmission control circuit, and is fixed by a fixing member to an automatic transmission case, wherein:
the actuator is disposed within the control unit case on an automatic transmission case side, and
the shift-by-wire control circuit and the automatic transmission control circuit are disposed within the control unit case on a side opposite the automatic transmission case side.

2. An automatic transmission control unit comprising:
an actuator that changes a travel range of an automatic transmission;
a shift-by-wire control circuit that controls the actuator in order to change the travel range of the automatic transmission to a selected range selected by a driver;
an automatic transmission control circuit that controls a shift speed of the automatic transmission by at least a travel range position signal; and
a control unit case that encloses the actuator, the shift-by-wire control circuit, and the automatic transmission control circuit, and is fixed by a fixing member to an automatic transmission case, wherein:
the actuator is disposed within the control unit case on a side where the control unit case is fixed to the automatic transmission case, and
the shift-by-wire control circuit and the automatic transmission control circuit are disposed on a side surface of the control unit case opposite to the side where the control unit case is fixed to the automatic transmission case.

3. The automatic transmission control unit according to claim 1, wherein
the control unit case has an attachment hole, and is fixed to the automatic transmission case using the attachment hole.

4. The automatic transmission control unit according to claim 1, further comprising:
a separation wall that divides an interior of the control unit case into two storage portions; and
a control circuit mechanism that includes the shift-by-wire control circuit and the automatic transmission control circuit and is fixed to a surface of the separation wall opposite a surface on an actuator side of the separation wall.

5. The automatic transmission control unit according to claim 1, wherein:
the control unit case has a lower storage portion on the automatic transmission case side, and an upper storage portion,
the actuator is accommodated in the lower storage portion, and
the shift-by-wire control circuit and the automatic transmission control circuit are accommodated in the upper storage portion.

6. The automatic transmission control unit according to claim 2, wherein:
the control unit case has a first storage portion on the side where the control unit case is fixed to the automatic transmission case, and a second storage portion on a side surface side of the control unit case,
the actuator is accommodated in the first storage portion, and
the shift-by-wire control circuit and the automatic transmission control circuit are accommodated in the second storage portion.

7. The automatic transmission control unit according to claim 5, wherein
the shift-by-wire control circuit and the automatic transmission control circuit structure a control circuit mechanism mounted on one printed circuit board.

8. The automatic transmission control unit according to claim 7, wherein:
the upper storage portion and the lower storage portion are divided by a separation wall, and
a conductor that electrically connects the actuator and the printed circuit board is embedded in the separation wall.

9. The automatic transmission control unit according to claim 6, wherein
the shift-by-wire control circuit and the automatic transmission control circuit structure a control circuit mechanism mounted on one printed circuit board.

10. The automatic transmission control unit according to claim 9, wherein:
the second storage portion and the first storage portion are divided by a separation wall, and
a conductor that electrically connects the actuator and the printed circuit board is embedded in the separation wall.

11. The automatic transmission control unit according to claim 2, wherein the control unit case has an attachment hole, and is fixed to the automatic transmission case using the attachment hole.

12. The automatic transmission control unit according to claim 2, further comprising:
a separation wall that divides an interior of the control unit case into two storage portions; and
a control circuit mechanism that includes the shift-by-wire control circuit and the automatic transmission control circuit and is fixed to a surface of the separation wall opposite a surface on an actuator side of the separation wall.

13. An automatic transmission control unit comprising:
an actuator that changes a travel range of an automatic transmission;
a shift-by-wire control circuit that controls the actuator in order to change the travel range of the automatic transmission to a selected range selected by a driver;
an automatic transmission control circuit that controls a shift speed of the automatic transmission by at least a travel range position signal; and
a control unit case that encloses the actuator, the shift-by-wire control circuit, and the automatic transmission control circuit, and is fixed by a fixing member to an automatic transmission case, wherein:
the control unit case is divided into a first storage portion that accommodates the actuator and a second storage portion that accommodates the shift-by-wire control circuit and the automatic transmission control circuit, and
the first storage portion is adjacent to the automatic transmission case.

14. The automatic transmission control unit according to claim 13, wherein the control unit case has an attachment hole, and is fixed to the automatic transmission case using the attachment hole.

15. The automatic transmission control unit according to claim 13, further comprising:
a separation wall that divides the control unit case into the first storage portion and the second storage portion.

16. The automatic transmission control unit according to claim 15, further comprising:
a control circuit mechanism that includes the shift-by-wire control circuit and the automatic transmission control circuit and is fixed to a surface of the separation wall in the second storage portion.

17. The automatic transmission control unit according to claim 13, wherein the first storage portion is a lower storage portion on an automatic transmission case side, and the second storage portion is an upper storage portion.

18. The automatic transmission control unit according to claim 13, wherein the second storage portion is located on a side surface of the control unit case.

19. The automatic transmission control unit according to claim 13, wherein the shift-by-wire control circuit and the automatic transmission control circuit structure a control circuit mechanism mounted on one printed circuit board.

20. The automatic transmission control unit according to claim 19, further comprising:
a conductor that electrically connects the actuator and the printed circuit board is embedded in the separation wall.
